(19) United States
(12) Patent Application Publication
(10) Pub. No.: US 2014/0284003 A1
(43) Pub. Date: Sep. 25, 2014

(54) ROMAN SHADE CURTAIN AND ROMAN SHADE USING THE SAME

(71) Applicant: DAEKYEONG TRIPLE CO., LTD., Daegu (KR)

(72) Inventor: Sang-Gun CHA, Daegu (KR)

(73) Assignee: DAEKYEONG TRIPLE CO., LTD., Daegu (KR)

(21) Appl. No.: 13/899,475

(22) Filed: May 21, 2013

(30) Foreign Application Priority Data
Mar. 20, 2013 (KR) 10-2013-0030019

(51) Int. Cl. E06B 9/40; E06B 9/262

(52) U.S. Cl. CPC E06B 9/40; E06B 9/262
USPC 160/84.04

(57) ABSTRACT

Disclosed herein are a roman shade curtain and a roman shade. The roman shade curtain includes a curtain and cord lines. In addition, the roman shade includes a rotating bar; a frame; a traction line; a curtain; and cord lines. Therefore, the roman shade curtain and the roman shade are integrally woven without forming a separate ring, are woven by a simple process, and have excellent durability.

### CROSS REFERENCE TO RELATED APPLICATION

This application claims the benefit of Korean Patent Application No. 10-2013-0030019, filed on Mar. 20, 2013, entitled “Roman Shade Curtain and Roman Shade Using the Same”, which is hereby incorporated by reference in its entirety into this application.

### BACKGROUND OF THE INVENTION

1. Technical Field

The present invention relates to a roman shade curtain and a roman shade using the same, and more particularly, to a roman shade curtain including reinforcing wefts and reinforcing warps, and a roman shade using the same.

2. Description of the Related Art

A curtain has been generally used in order to shield light or hide a thing in our daily lives, for example, in order to shield sunlight, the stage, or the like. There are several kinds of curtains according to forms. For example, there are a general curtain unfolded and folded in a horizontal direction, a vertical blind configured of a plurality of pieces adjusting an inclined angle, a roll screen curtain in which a curtain is wound around and unwound from a roll, a roman shade folded by a winding operation of a length adjusting line.

Recently, as an aesthetic element of the curtain as well as a function of the curtain has been considered as being important, a roman shade of which a folded shape is beautiful has been popular. In the roman shade, basically, since a curtain part is folded and is raised to form a plurality of layers, when the roman shade is completely raised, an appearance of the roman shade is beautiful.

The roman shade type blind according to the related art as described above has been disclosed in KR 10-1153854. FIG. 1 is a front view showing a roman shade type blind according to the related art; and FIG. 2 is a partial side cross-sectional view showing the roman shade type blind according to the related art. The roman shade type blind according to the related art is configured to include a fabric 3; rings 4; and a cord line 5. The fabric 3 is woven by interweaving warps 1 and wefts 2 with each other as shown in FIG. 1. However, some of the wefts 2 are not interweaved with the warps 1, such that the rings 4 are formed. Referring to FIG. 2, the warps 1 are interweaved with the wefts 2 except for some wefts 2 while passing between the wefts 2, such that the wefts 2 at a portion at which the warps 1 do not pass are collected to form the ring 4. Therefore, the cord line 5 passes through the ring 4 formed as described above, such that the roman shade type blind according to the related art is completed.

However, in the roman shade type blind according to the related art, the ring 4 should be separately configured in order to connect the cord line 5 to the fabric 3. To this end, since some wefts 2 are separately configured so as not to be interweaved with the warps 1, a weaving process is complicated.

In addition, since some wefts 2 are not interweaved with the warps 1 in order to form the ring 4, durability of a corresponding portion is weak.

### SUMMARY OF THE INVENTION

An object of the present invention is to provide a roman shade curtain integrally woven by including reinforcing wefts and reinforcing warps, and a roman shade using the same.

According to an exemplary embodiment of the present invention, there is provided a roman shade curtain including: a curtain woven by interweaving warps and wefts with each other and including reinforcing wefts interweaved with the warps; and cord lines passing between the wefts and the reinforcing wefts and then fixed to a lower end of the curtain.

According to another exemplary embodiment of the present invention, there is provided a roman shade curtain including:

a curtain woven by interweaving warps and wefts with each other and including reinforcing warps interweaved with the wefts; and cord lines passing between the warps and the reinforcing warps and then fixed to a lower end of the curtain.

According to still another exemplary embodiment of the present invention, there is provided a roman shade including: a rotating bar; a frame having a shaft of both ends of the rotating bar connected to both ends of an inner side thereof; a traction line installed at one end of the rotating bar to adjust rotation of the rotating bar; a curtain woven by interweaving warps and the wefts with each other, having an upper end connected to the frame, and including reinforcing wefts interweaved with the warps; and cord lines having one end fixed to the rotating bar and the other end passing between the wefts and the reinforcing wefts and then fixed to a lower end of the curtain.

According to still another exemplary embodiment of the present invention, there is provided a roman shade including: a rotating bar; a frame having a shaft of both ends of the rotating bar connected to both ends of an inner side thereof; a traction line installed at one end of the rotating bar to adjust rotation of the rotating bar; a curtain woven by interweaving warps and wefts with each other, having an upper end connected to the frame, and including reinforcing warps interweaved with the wefts; and cord lines having one end fixed to the rotating bar and the other end passing between the warps and the reinforcing warps and then fixed to a lower end of the curtain.

### BRIEF DESCRIPTION OF THE DRAWINGS

FIG. 1 is a front view showing a roman shade type blind according to the related art;

FIG. 2 is a partial side cross-sectional view showing a roman shade type blind according to the related art;

FIG. 3 is a perspective view showing a first exemplary embodiment of a roman shade according to the present invention;

FIG. 4 is a partially enlarged view showing a first exemplary embodiment of a roman shade according to the present invention;

FIG. 5 is a partial side cross-sectional view showing a first exemplary embodiment of a roman shade curtain according to the present invention;

FIG. 6 is a front view showing a second exemplary embodiment of a roman shade according to the present invention;

FIG. 7 is a partially enlarged view showing a second exemplary embodiment of a roman shade according to the present invention;

FIG. 8 is a partial side cross-sectional view showing a second exemplary embodiment of a roman shade curtain according to the present invention;

FIG. 9 is a front view showing a third exemplary embodiment of a roman shade according to the present invention;

FIG. 10 is a partially enlarged view showing a third exemplary embodiment of a roman shade according to the present invention;

FIGS. 11A and 11B are views showing an operation state of an interval maintaining member of the roman shade according to the present invention;

FIG. 12 is a perspective view showing a fixing bead of the roman shade according to the present invention; and

FIGS. 13A and 13B are views showing operation states of the interval maintaining member and the fixing bead of the roman shade according to the present invention.

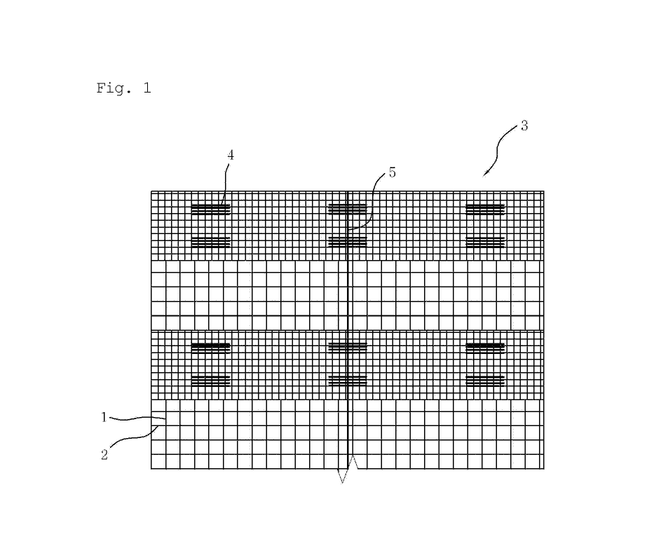

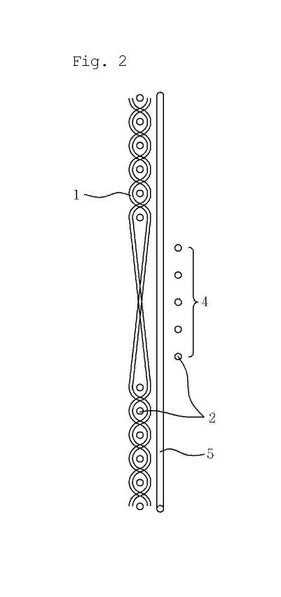

### DESCRIPTION OF THE PREFERRED EMBODIMENTS

Hereinafter, a roman shade curtain and a roman shade using the same according to the present invention will be described in more detail with reference to the accompanying drawings.

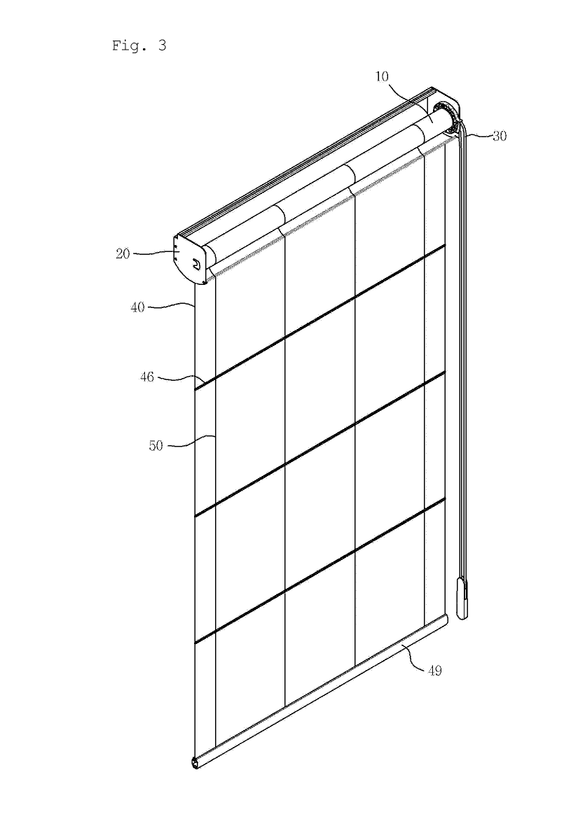

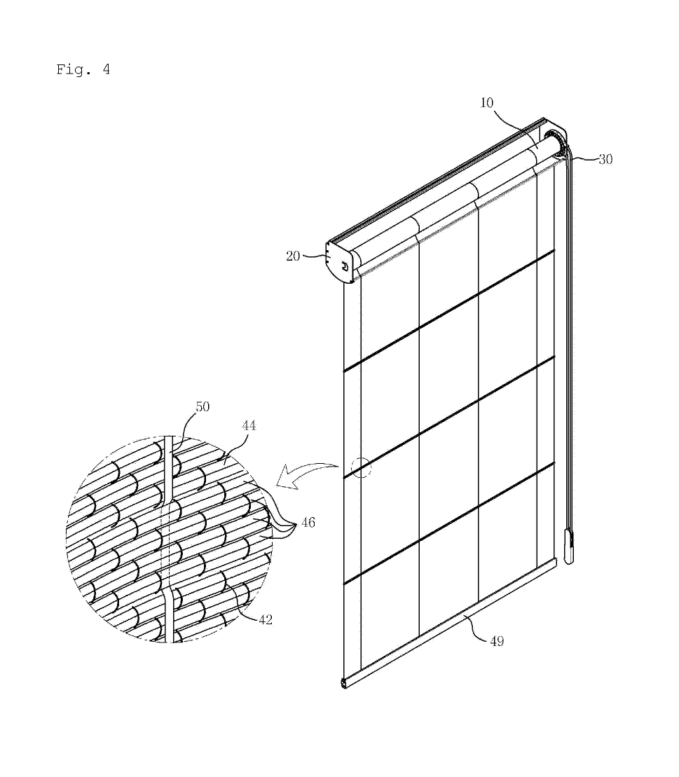

The present invention relates to a roman shade. FIG. 3 is a perspective view showing a first exemplary embodiment of a roman shade according to the present invention; FIG. 4 is a partially enlarged view showing a first exemplary embodiment of a roman shade according to the present invention; and FIG. is a partial side cross-sectional view showing a first exemplary embodiment of a roman shade curtain according to the present invention.

The roman shade curtain according to the present invention is configured to include a curtain 40 woven by interweaving warps 42 and wefts 44 with each other and including reinforcing wefts 46 interweaved with the warps 42;

and cord lines 50 passing between the wefts 44 and the reinforcing wefts 46 and then fixed to a lower end of the curtain 40.

In addition, the roman shade according to the present invention is configured to include a rotating bar 10; a frame having a shaft of both ends of the rotating bar 10 connected to both ends of an inner side thereof; a traction line 30 installed at one end of the rotating bar 10 to adjust rotation of the rotating bar 10; the curtain 40 woven by interweaving the warps 42 and the wefts 44 with each other, having an upper end connected to the frame 20, and including the reinforcing wefts 46 interweaved with the warps 42; and the cord lines 50 having one end fixed to the rotating bar 10 and the other end passing between the wefts 44 and the reinforcing wefts 46 and then fixed to the lower end of the curtain 40.

Hereinafter, the respective components of the roman shade curtain and the roman shade using the same according to the present invention will be described in detail.

The rotating bar 10, which is a component rotated in order to operate the roman shade according to the present invention, has the shaft connected to a frame 20 to be described below.

The frame 20 has both ends of the inner side connected to the shaft of both ends of the rotating bar 10 as shown in FIG. 3, thereby allowing the rotating bar 10 to be rotated with respect to the frame 20. The frame 20 is attached to a position which the roman shade according to the present invention is installed to serve to support the roman shade.

The traction line 30 is wound around one end of the rotating bar 10 to serve to adjust the rotation of the rotating bar 10. Since a structure in which the traction line is connected to the rotating bar 10 is well-known, a detailed description thereof will be omitted.

The curtain 40 is woven by interweaving the warps 42 and the wefts 44 and has the upper end connected to the frame 20 to serve to directly shield sunlight or hide a thing.

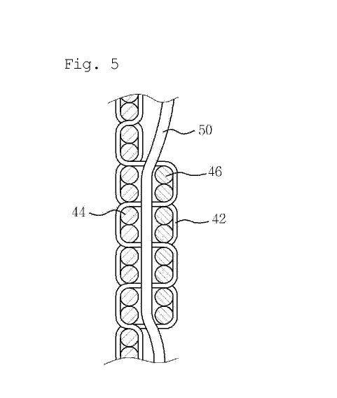

The reinforcing wefts 46, which are a first exemplary embodiment of the roman shade curtain and the roman shade according to the present invention, are components woven integrally with the curtain 40 at the time of weaving the curtain 40 since they are placed over the wefts 44 and are interwoven with the warps 42 as shown in FIGS. 4 and 5 and allowing cord lines 50 to be described below to pass therethrough. A plurality of reinforcing wefts 46 may be installed in a length direction of the warp 42. Places through which the cord lines 50 pass increase by the number of reinforcing wefts 46 to be installed, such that the number of layers formed when the roman shade according to the present invention is folded is determined.

A tension maintaining bar 49 is a component installed at a lower end of the curtain 40 while having a predetermined weight as shown in FIG. 3 to allow gravity corresponding to the predetermined weight to be applied to the curtain 40, thereby allowing the curtain 40 to be less shaken by external impact.

The cord line 50 has one end fixed to the rotating bar 10 to thereby be wound or unwound according to the rotation of the rotating bar 10 and has the other end passing between the weft 44 and the reinforcing weft 46 and then fixed to the lower end of the curtain. That is, a space is formed between the reinforcing wefts 46 woven together with the curtain 40 at the time of weaving the curtain 60 and the wefts 44 without a separate ring or hole and the cord line 50 passes through the space as shown in FIGS. 4 and 5, such that the roman shade according to the present invention is implemented. However, it is preferable that a material of the cord line 50 is nylon 66. The reason is that a surface of the nylon 66 is not rough, such that the nylon 66 easily passes through textiles having a narrow gap without being caught by the textiles and has high strength.

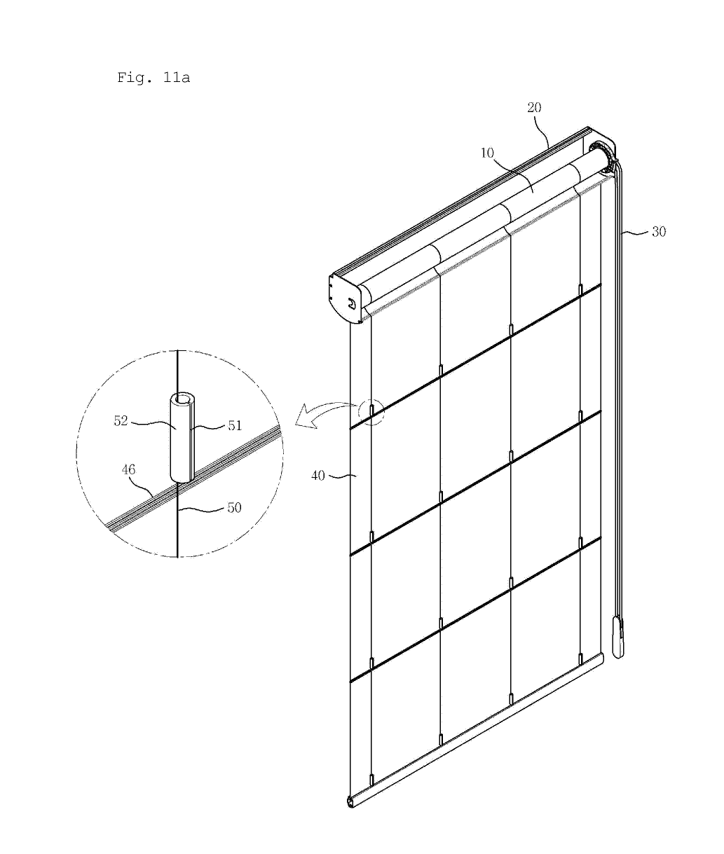

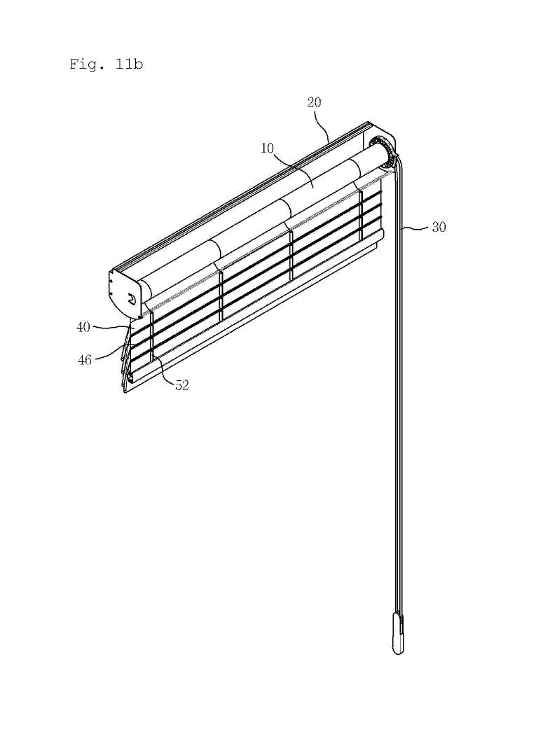

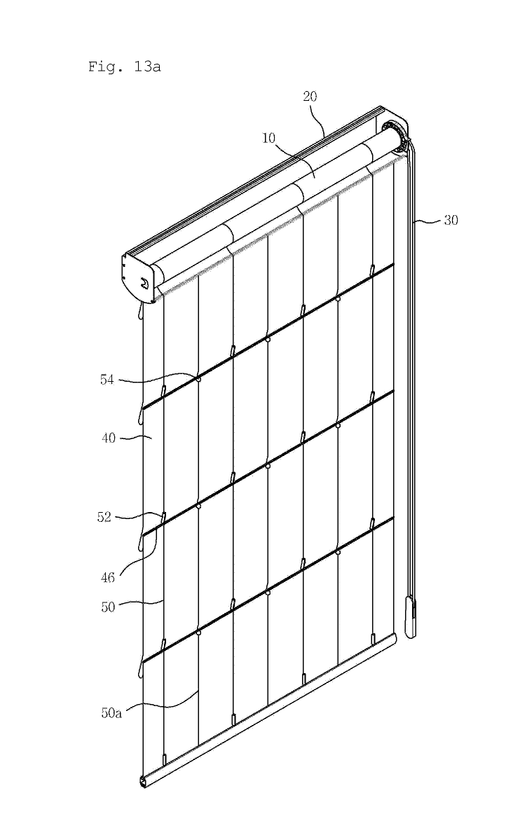

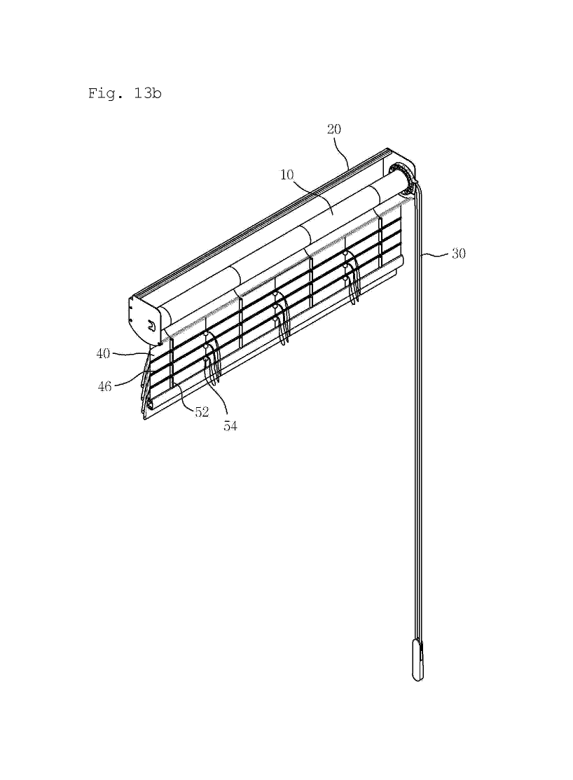

Meanwhile, the number of layers formed when the roman shade is folded is determined according to the number of reinforcing wefts 46 through which the cord line 50 passes. When one end of the cord line 50 is wound around the rotating bar 10 by the rotation of the rotating bar 10, the lower end of the curtain 40 connected to the other end of the cord line is raised. When the lower end of the curtain 40 is continuously raised, the lower end of the curtain 40 contacts the reinforcing weft 46 through which the cord line 50 passes to form the layer. Likewise, the reinforcing weft 46 contacting the lower end of the curtain 40 and another reinforcing weft 46 positioned on the reinforcing weft 46 and having the cord line 50 passing therethrough contact each other to form a layer. When the above-mentioned process is repeated up to a reinforcing weft 46 positioned at the uppermost portion, layers having the number corresponding to that of woven reinforcing wefts as shown in FIGS. 11B and 13B are formed.

In addition, a plurality of cord lines 50 may be installed in a length direction of the reinforcing weft 46. It is preferable that the cord lines 50 are formed to be horizontally symmetrical to each other, having a predetermined interval therebetween. This is to allow the curtain 40 to be stably folded or unfolded.

In the roman shade according to the present invention, since the reinforcing wefts 46 are woven without forming a separate ring or hole and the cord lines 50 may pass between the wefts 44 and the reinforcing wefts 46, when the curtain 40 is woven, a separate setting or design is not required. Further, in the case in which the cord lines 50 are further installed after the curtain 40 is woven, it is only required to pass the cord lines 50 between the woven reinforcing wefts 46 and the wefts 44 without installing an additional ring or hole.

Hereinafter, second and third exemplary embodiments of a roman shade curtain and a roman shade according to the present embodiments will be described.

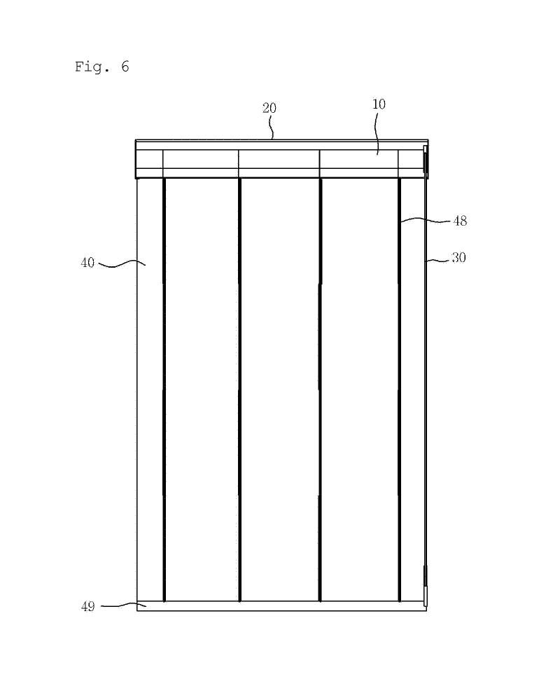

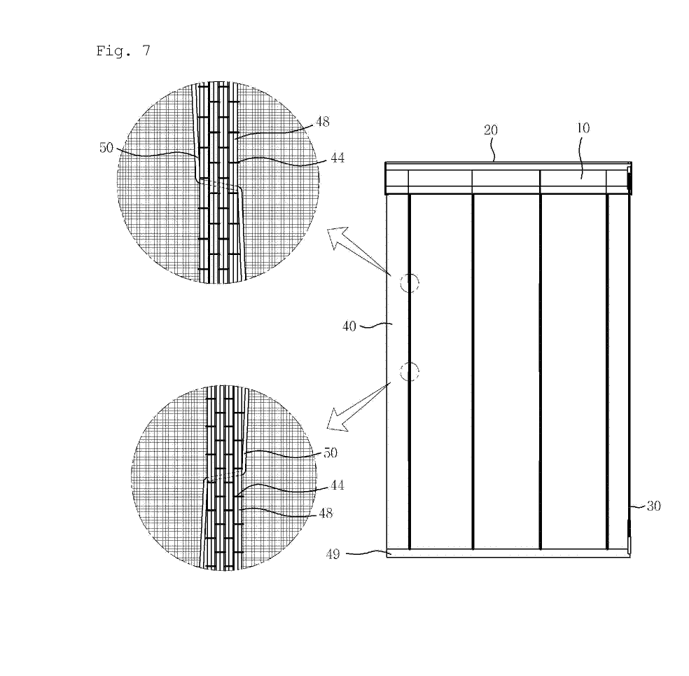

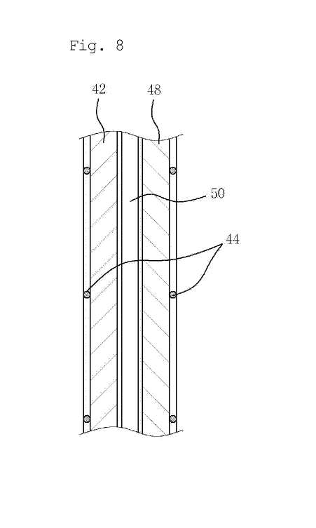

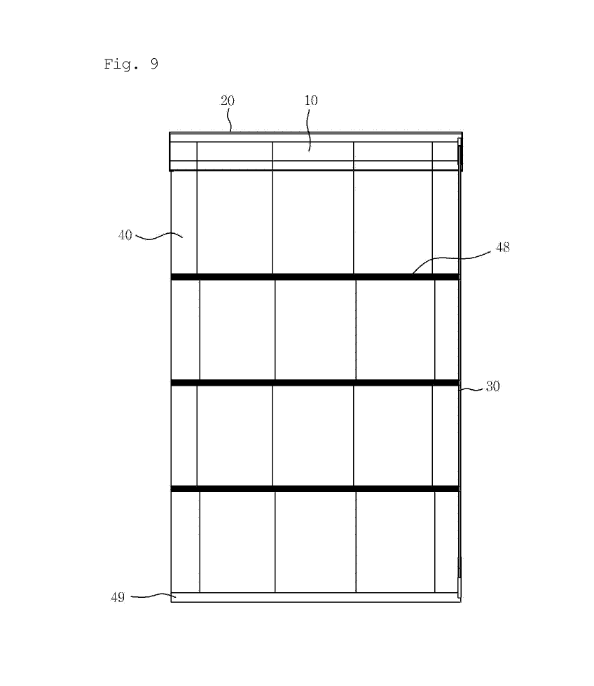

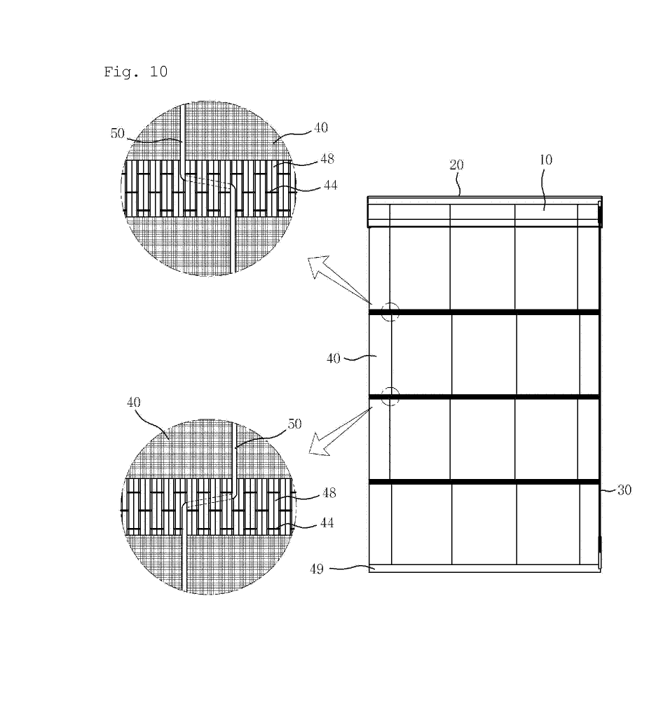

FIG. 6 is a front view showing a second exemplary embodiment of a roman shade according to the present invention; FIG. 7 is a partially enlarged view showing a second exemplary embodiment of a roman shade according to the present invention; FIG. 8 is a partial side cross-sectional view showing a second exemplary embodiment of a roman shade curtain according to the present invention; FIG. 9 is a front view showing a third exemplary embodiment of a roman shade according to the present invention; and FIG. 10 is a partially enlarged view showing a third exemplary embodiment of a roman shade according to the present invention.

The roman shade curtain according to the present invention is configured to include a curtain 40 woven by interweaving warps 42 and wefts 44 with each other and including reinforcing warps 48 interweaved with the wefts 44; and cord lines 50 passing between the warps 42 and the reinforcing warps 48 and then fixed to a lower end of the curtain 40.

In addition, the roman shade according to the present invention is configured to include a rotating bar 10; a frame having a shaft of both ends of the rotating bar 10 connected to both ends of an inner side thereof; a traction line 30 installed at one end of the rotating bar 10 to adjust rotation of the rotating bar 10; the curtain 40 woven by interweaving the warps 42 and the wefts 44 with each other, having an upper end connected to the frame 20, and including the reinforcing warps 48 interweaved with the wefts 44; and the cord lines 50 having one end fixed to the rotating bar 10 and the other end passing between the warps 42 and the reinforcing warps 48 and then fixed to the lower end of the curtain 40.

Since the rotating bar 10, the frame 20, the traction line 30, and the like, are the same as the rotating bar 10, the frame 20, the traction line 30, and the like, described above, a description thereof will be omitted.

First, the second exemplary embodiment of a roman shade according to the present invention will be described. In the second exemplary embodiment of the roman shade, the reinforcing warps 48 are vertically disposed instead of the reinforcing wefts 46 and are interwoven with the wefts 44 as shown in FIG. 6. The reinforcing warps 48 are also components woven integrally with the curtain 40 at the time of weaving the curtain 40 since they are placed over the warps 42 and are interwoven with the wefts 44 and allowing cord lines 50 to be described below to pass therethrough. The cord lines 50 pass between the warps 42 and the reinforcing warps 48 as shown in FIG. 8. Unlike the reinforcing wefts 46, even though the number of reinforcing warps 48 formed vertically is only one, the number of layers formed in the curtain 40 may be adjusted to be plural. Referring to FIG. 7, the cord line 50 descends at the left based on a single reinforcing warp 48, passes between the reinforcing warp 48 and the warp 42, moves to the right, and then descends. Likewise, since the cord line 50 is connected to the curtain 40 while repeating a process in which the cord line 50 passes from the right to the left and from the left to the right, even though only one reinforcing warp 48 is formed, a plurality of layers may be formed.

However, the number of reinforcing warps 48 may also be plural. This is to additionally form the cord lines 50 so as to correspond to the additionally formed reinforcing warps 48, thereby allowing the curtain 40 to be stably folded or unfolded.

Meanwhile, in the third exemplary embodiment of the roman shade according to the present invention, the reinforcing warps 48 are formed in a length direction of the weft 44, that is, in a horizontal direction. As shown in FIG. 9, the reinforcing warps 48 are formed in a horizontal direction of the curtain 40. Similar to the second exemplary embodiment, in the third exemplary embodiment, the reinforcing warps 48 are placed over the warps 42 and are interwoven with the wefts 44, such that they are woven integrally with the curtain 40 at the time of weaving the curtain 40, and the cord line 50 passes from the left to the right and from the right to the left between the reinforcing warp 48 and the warp 42, as shown in FIG. 10. However, unlike the second exemplary embodiment, in the third exemplary embodiment, the reinforcing warp 48 is horizontally woven, thereby making it possible to accomplish an effect similar to that of the first exemplary embodiment, that is, to allow a plurality of cord lines 50 to penetrate through a single reinforcing warp 48.

Meanwhile, in the third exemplary embodiment, a plurality of reinforcing warps 48 are formed according to the warps 42, the number of cord lines 50 that may penetrate through the reinforcing warps 48 is determined according to the number of reinforcing warps 48, and layers having the number corresponding to the number of cord lines 50 penetrating through the reinforcing warps 48 are formed when the curtain is folded.

Hereinafter, additional components of the roman shade according to the present invention will be described.

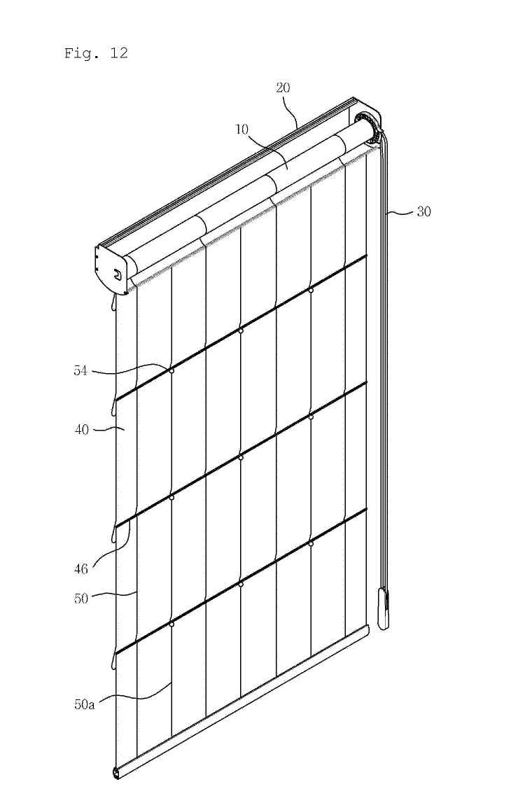

FIGS. 11A and 11B are views showing an operation state of an interval maintaining member of the roman shade according to the present invention; FIG. 12 is a perspective view showing a fixing bead of the roman shade according to the present invention; and FIGS. 13A and 13B are views showing operation states of the interval maintaining member and the fixing bead of the roman shade according to the present invention.

The interval maintaining members 52, which include a slit 51 formed at a side thereof and have a cylindrical shape, are installed on the cord lines 50 as shown in FIG. 11A to allow the layers to be formed at predetermined intervals when the curtain 40 is folded. The interval maintaining members 52 are present on the cord lines 50 between the reinforcing wefts 46 when the layers are formed, such that the reinforcing wefts 46 do not directly contact each other, but have the interval maintaining member 52 positioned therebetween, thereby making it possible to allow a predetermined interval to be maintained. Therefore, as shown in FIG. 11B, when the curtain 40 is folded, the interval maintaining members 52 allow the layers to be formed, having predetermined intervals therebetween, when the curtain 40 is folded.

The fixing beads 54, which include a through-hole formed therein and have a bead shape, are not fixed to the rotation bar 10, but are fixed to auxiliary cord lines 50a fixed to upper and lower ends of the curtain 40, as shown in FIG. 12. Therefore, when the curtain 40 is unfolded, the fixing beads 54 fixed to the auxiliary cord lines 50a are caught by the reinforcing wefts 46, such that the curtain 40 is no longer unfolded and the layers are formed.

Meanwhile, the roman shade according to the present invention in which the fixing beads 54 are formed may further include interval maintaining members 52. Referring to FIG.

13A, when the curtain 40 is unfolded, the curtain 40 is not completely unfolded by the fixing beads 54, but forms the layers. On the other hand, when the curtain 40 is folded, the layers are formed at predetermined intervals in the curtain 40 by the interval maintaining member 52, as shown in FIG. 13B.

The roman shade curtain and the roman shade using the same according to the exemplary embodiments of the present invention are integrally woven without forming a separate ring, are woven by a simple process, and have excellent durability.

1. A roman shade curtain comprising:
a curtain woven by interweaving warps and wefts with each other and including reinforcing wefts interweaved with the warps; and
cord lines passing between the wefts and the reinforcing wefts and then fixed to a lower end of the curtain.

2. The roman shade curtain of claim 1, wherein a plurality of reinforcing wefts are provided in a length direction of the warp.

3. The roman shade curtain of claim 2, wherein a plurality of cord lines are installed in a length direction of the reinforcing weft.

4. A roman shade curtain comprising:
a curtain woven by interweaving warps and wefts with each other and including reinforcing warps interweaved with the wefts; and
cord lines passing between the warps and the reinforcing warps and then fixed to a lower end of the curtain.

5. The roman shade curtain of claim 4, wherein a plurality of reinforcing warps are provided in a length direction of the weft, and the cord lines having the number corresponding to the number of reinforcing warps are provided and are installed at positions corresponding to those of the reinforcing warps.

6. The roman shade curtain of claim 4, wherein a plurality of reinforcing warps are provided in a length direction of the warp.

7. The roman shade curtain of claim 6, wherein a plurality of cord lines are installed in a length direction of the reinforcing warp.

8. A roman shade comprising:
a rotating bar;
a frame having a shaft of both ends of the rotating bar connected to both ends of an inner side thereof;
a traction line installed at one end of the rotating bar to adjust rotation of the rotating bar;
a curtain woven by interweaving warps and the wefts with each other, having an upper end connected to the frame, and including reinforcing wefts interweaved with the warps; and
cord lines having one end fixed to the rotating bar and the other end passing between the wefts and the reinforcing wefts and then fixed to a lower end of the curtain.

9. The roman shade of claim 8, wherein a plurality of reinforcing wefts are provided in a length direction of the warp.

10. The roman shade of claim 9, wherein a plurality of cord lines are installed in a length direction of the reinforcing weft.

11. A roman shade comprising:
a rotating bar;
a frame having a shaft of both ends of the rotating bar connected to both ends of an inner side thereof;
a traction line installed at one end of the rotating bar to adjust rotation of the rotating bar;
a curtain woven by interweaving warps and wefts with each other, having an upper end connected to the frame, and including reinforcing warps interweaved with the wefts; and
cord lines having one end fixed to the rotating bar and the other end passing between the warps and the reinforcing warps and then fixed to a lower end of the curtain.

12. The roman shade of claim 11, wherein a plurality of reinforcing warps are provided in a length direction of the weft, and the cord lines having the number corresponding to the number of reinforcing warps are provided and are installed at positions corresponding to those of the reinforcing warps.

13. The roman shade of claim 11, wherein a plurality of reinforcing warps are provided in a length direction of the warp.

14. The roman shade of claim 13, wherein a plurality of cord lines are installed in a length direction of the reinforcing warp.

15. The roman shade of claim 8, further comprising auxiliary cord lines having one end fixed to an upper end of the curtain and the other end passing between the wefts and the reinforcing wefts and then fixed to the lower end of the curtain and fixing beads provided on the auxiliary cord lines.

16. The roman shade of claim 11, further comprising auxiliary cord lines having one end fixed to an upper end of the curtain and the other end passing between the warps and the reinforcing warps and then fixed to the lower end of the curtain and fixing beads provided on the auxiliary cord lines.

17. The roman shade of claim 8, further comprising cylindrical interval maintaining members installed on the cord lines and having a slit formed at a side thereof

18. The roman shade of claim 11, further comprising a tension maintaining bar installed at the lower end of the curtain.

19. The roman shade of claim 11, further comprising cylindrical interval maintaining members installed on the cord lines and having a slit formed at a side thereof.

20. The roman shade of claim 11, further comprising a tension maintaining bar installed at the lower end of the curtain.
